(19) United States
(12) Patent Application Publication
(10) Pub. No.: US 2012/0218465 A1
(43) Pub. Date: Aug. 30, 2012

(54) ILLUMINATION ADJUSTMENT CIRCUIT FOR FLASH, FLASH DEVICE AND IMAGE CAPTURE DEVICE USING SAME

(75) Inventor: Yusuke Kanamaru, Osaka (JP)

(73) Assignee: Panasonic Corporation, Osaka (JP)

(21) Appl. No.: 13/503,742

(22) PCT Filed: Nov. 10, 2010
(86) PCT No.: PCT/JP2010/006582

§ 371 Date: Apr. 24, 2012

(30) Foreign Application Priority Data
Nov. 16, 2009 (JP) 2009-260592

(51) Int. Cl. H04N 5/222; H05B 37/02

(52) U.S. Cl. 348/371; 315/158; 348/E05.038

(57) ABSTRACT

An illumination adjustment circuit for flash of the present invention includes a light receiving element for generating a photoelectric current responsive to the intensity of the light reflected from a subject, a voltage integrating section for voltage-integrating the photoelectric current from the light receiving element, and a voltage comparing section for comparing a voltage of the voltage integrating section with a reference voltage. The illumination adjustment circuit further includes a current ratio varying section for outputting a variable current to the voltage integrating section with the passage of light emission time.

### TECHNICAL FIELD

The present invention relates to an illumination adjustment circuit for flash that adjusts the light emission amount of the light emitted from a flash discharge tube, and a flash device and image capture device using the illumination adjustment circuit.

### BACKGROUND ART

A conventional flash device has an illumination adjustment circuit in order to adjust the light emission amount of the light emitted from a flash discharge tube. In the illumination adjustment circuit for flash, the light reflected from a subject during flash light emission is received and photo-electrically converted into photoelectric current by a semiconductor light receiving element. A voltage integrating section integrates the light amount of the photo-electrically converted photoelectric current. A voltage comparing section compares the integrated voltage value of the voltage integrating section with a reference voltage value corresponding to the photoelectric current that is obtained by photo-electrically converting the light emission amount of the emitted light appropriate for the subject. The voltage comparing section then outputs a light emission stop signal when the integrated voltage value exceeds the reference voltage value.

In other words, the illumination adjustment circuit for flash outputs the light emission stop signal when the light emission amount of the light emitted from the flash discharge tube arrives at the light emission amount of the emitted light appropriate for the subject. The flash discharge tube receives the light emission stop signal and stops flash light emission.

As the semiconductor light receiving element for photo-electrically converting the light reflected from the subject, a light receiving element such as a photodiode or phototransistor for making photoelectric current flow in response to the intensity of the coming emitted light is used.

During short-range photographing, for example when the photographing distance is short, the photographing sensitivity is high, or the stationary light is relatively strong, the semiconductor light receiving element receives much light reflected from the subject in a short time. Therefore, the current amount of the photoelectric current photo-electrically converted by the semiconductor light receiving element increases in a short time. The integrated voltage value, in a short time, arrives at the reference voltage value indicating arrival at the appropriate light emission amount. However, the light emission amount of the light actually emitted from the flash discharge tube at this time is smaller than that during normal photographing. The emitted light during the short-range photographing is called feeble light emission. The illumination adjustment circuit for flash therefore requires a correcting means for correcting the reference voltage value so that the reference voltage value is appropriate for each of the short-range photographing and normal photographing.

As the correcting means of the reference voltage value, an illumination adjustment device for flash of Patent Literature 1 is disclosed, for example. This illumination adjustment device for flash is set so that the integrated voltage value is a predetermined voltage at the start of the light emission by the flash discharge tube, and then the integrated voltage value gradually increases to the reference voltage value. The illumination adjustment circuit for flash can prevent the light emission amount from becoming an excessive error during the short-range photographing.

The applicant of the present invention has proposed an illumination adjustment device for flash having a plurality of voltage integrating sections for integrating voltage at different voltage increasing rates, as disclosed in Patent Literature 2. The illumination adjustment device for flash switches the reference voltage value so as to achieve the following condition:
flash light emission is stopped when the integrated voltage value by the voltage integrating section of the higher voltage increasing rate arrives at the reference voltage value before the passage of a preset predetermined time from the start of the light emission; and
flash light emission is stopped when the integrated voltage value by the voltage integrating section of the lower voltage increasing rate arrives at the reference voltage value after the passage of the predetermined time.

In the configuration of the illumination adjustment device for flash disclosed in Patent Literature 1, the gas in the flash discharge tube is excited, so that a noise component can occur in the integrated voltage value or the voltage can fluctuate due to trigger noise occurring when trigger voltage is applied to the flash discharge tube.

In this case, the integrated voltage value can temporarily exceed the reference voltage value while the reference voltage value is increasing. When the integrated voltage value temporarily exceeds the reference voltage value, the voltage comparing section outputs a light emission stop signal in response to the exceeding and the light emission by the flash discharge tube can stop.

In the configuration of the illumination adjustment device for flash disclosed in Patent Literature 2, the voltage integrating section is switched in response to the elapsed time from the start of the light emission. In this illumination adjustment circuit for flash, the characteristic curve of the integrated voltage value derived from the time difference for switch (for example, 5 μsec or more and 10 μsec or less), integrated voltage, and passage of time becomes discontinuous. When the light emission stop control is performed many times during switch, an error can occur dependently on which of the characteristic curves of different voltage integrating sections is employed.

### CITATION LIST

### Patent Literature

PLT 1 Unexamined Japanese Utility Model Publication No. S58-163936
PLT 2 Unexamined Japanese Patent Publication No. 2008-26763

### SUMMARY OF THE INVENTION

The present invention addresses the above-mentioned problems, and provides an illumination adjustment circuit for flash capable of improving the illumination adjustment accuracy for each light emission/photographing condition, and a flash device using the illumination adjustment circuit.

An illumination adjustment circuit for flash of the present invention includes the following elements:
a light receiving element for generating a photoelectric current responsive to the intensity of the light reflected from a subject;
a voltage integrating section for voltage-integrating the photoelectric current from the light receiving element; and
a voltage comparing section for comparing a voltage of the voltage integrating section with a reference voltage.
   The illumination adjustment circuit for flash further includes a current ratio varying section for outputting a variable current to the voltage integrating section with the passage of light emission time.

In this configuration, the time until the integrated voltage arrives at the reference voltage can be varied by outputting the variable current from the current ratio varying section to the voltage integrating section. In other words, in the light emission/photographing condition requiring feeble light emission, for example when the photographing distance is short, the photographing sensitivity is high, or the stationary light is relatively strong, the current ratio varying section increases the variable current in order to shorten the time until the integrated voltage arrives at the reference voltage. Thus, the integrated voltage can increase the voltage increasing rate. In the light emission/photographing condition requiring a normal light emission amount, the current ratio varying section decreases the variable current. Thus, the integrated voltage can match the time until the integrated voltage arrives at the reference voltage with the time capable of securing the light emission amount of the emitted light, so that the illumination adjustment accuracy for each light emission/photographing condition can be improved.

Thus, the illumination adjustment circuit for flash can adjust the light emission amount of the emitted light for each light emission/photographing condition only by varying the variable current with the current ratio varying section. The illumination adjustment circuit for flash is not required to set the reference voltage value for each light emission/photographing condition, and can reduce the error following the switch of the reference voltage value for each light emission/photographing condition.

The flash device of the present invention includes an illumination adjustment circuit for flash and a light emitting element for emitting light.

In this configuration, the light emission amount of the emitted light can be adjusted for each light emission/photographing condition only by varying the variable current with the current ratio varying section. Thus, the flash device is not required to set the reference voltage value for each light emission/photographing condition, and can reduce the error following the switch of the reference voltage value for each light emission/photographing condition.

An image capture device of the present invention includes a flash device, an image capture element, and an optical system for image capture.

In this configuration, optimized flash light emission control is performed by light emission control where the error of the light emission amount is reduced, so that the error of the exposure amount during photographing can be reduced.

Thus, the present invention can improve the illumination adjustment accuracy for each light emission/photographing condition.

### BRIEF DESCRIPTION OF DRAWINGS

FIG. 1 is a schematic circuit diagram of a flash device in accordance with a first exemplary embodiment of the present invention.

FIG. 2 is a circuit diagram of an illumination adjustment circuit for flash in accordance with the first exemplary embodiment of the present invention.

FIG. 3A is a graph showing variation in photoelectric current of a semiconductor light receiving element and variation in additional current of a current ratio varying section in accordance with the first exemplary embodiment of the present invention.

FIG. 3B is a graph showing variation in integrated voltage of a voltage integrating section and output timing of a light emission stop signal in accordance with the first exemplary embodiment of the present invention.

FIG. 4A is a graph showing variation in photoelectric current of a semiconductor light receiving element and variation in additional current of a current ratio varying section in accordance with a second exemplary embodiment of the present invention.

FIG. 4B is a graph showing variation in integrated voltage of a voltage integrating section and output timing of a light emission stop signal in accordance with the second exemplary embodiment of the present invention.

FIG. 5 is a schematic front view of a flash device in accordance with a third exemplary embodiment of the present invention.

FIG. 6 is a schematic front view of an image capture device in accordance with a fourth exemplary embodiment of the present invention.

### DESCRIPTION OF EMBODIMENTS

Exemplary embodiments of the present invention will be described hereinafter with reference to the accompanying drawings. In the following drawings, similar elements are denoted with the same reference marks, and the descriptions of those elements are omitted.

### First Exemplary Embodiment

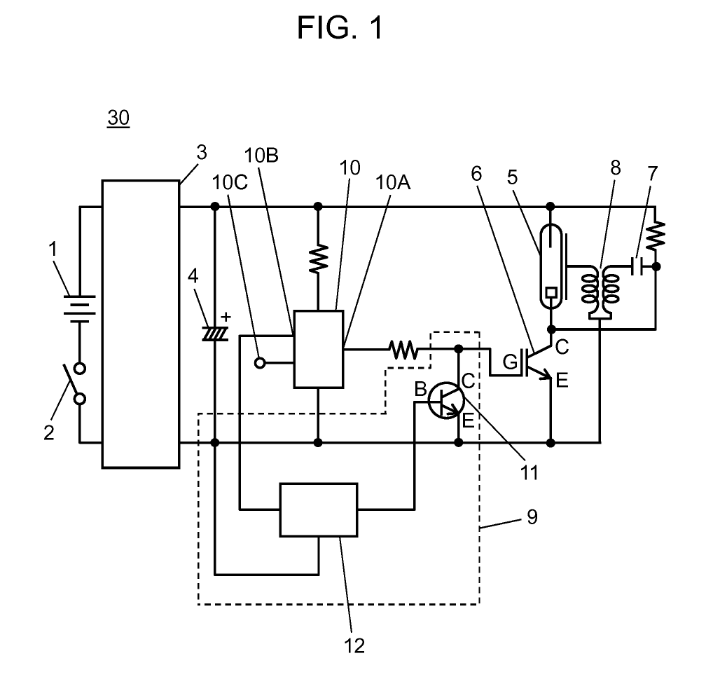

A schematic configuration of a flash device of a first exemplary embodiment of the present invention is described with reference to FIG. 1. FIG. 1 is a schematic circuit diagram of flash device 30 in accordance with the first exemplary embodiment of the present invention.

Flash device 30 of the first exemplary embodiment includes power supply battery 1, power supply switch 2, voltage boost circuit 3, main capacitor 4, flash discharge tube 5, insulated gate bipolar transistor (IGBT) 6, trigger capacitor 7, trigger transformer 8, light emission stop circuit 9, and light emission control circuit 10. Power supply battery 1 supplies electric power to flash device 30, and power supply switch 2 switches ON and OFF of power supply battery 1. Voltage boost circuit 3 increases the terminal voltage of power supply battery 1 to a direct-current (DC) high voltage, and main capacitor 4 is charged by the DC high voltage output from voltage boost circuit 3. Then, flash discharge tube 5, which is one of light emitting elements, is connected to both ends of main capacitor 4, and emits light. IGBT 6 controls ON and OFF of flash discharge tube 5, and trigger capacitor 7 and trigger transformer 8 excite flash discharge tube 5. Light emission stop circuit 9 stops light emission of flash discharge tube 5, and light emission control circuit 10 outputs driving voltages of IGBT 6 and light emission stop circuit 9.

Light emission stop circuit 9 includes off-transistor 11 and illumination adjustment circuit 12. A point between collector C and emitter E of off-transistor 11 is connected to a point between gate G and emitter E of IGBT 6, and off-transistor 11 turns off IGBT 6. Illumination adjustment circuit 12 is connected to base B of off-transistor 11, and outputs a light emission stop signal in response to the light emission amount of the light emitted from flash discharge tube 5.

Light emission control circuit 10 is connected to both ends of main capacitor 4. Light emission control circuit 10 outputs driving voltage of IGBT 6 from first terminal 10A, and outputs driving voltage of light emission stop circuit 9 from second terminal 10B. Light emission control circuit 10 inputs a light emission start signal at input terminal 10C.

Next, an operation of flash device 30 having the above-mentioned configuration is simply described. First, in a state where main capacitor 4 and trigger capacitor 7 have been already charged by the operation of voltage boost circuit 3, the light emission start signal is supplied to input terminal 10C of light emission control circuit 10. Then, light emission control circuit 10 outputs driving voltage of IGBT 6 from first terminal 10A, and outputs driving voltage of light emission stop circuit 9 from second terminal 10B.

Therefore, IGBT 6 turns on, simultaneously trigger capacitor 7 discharges via trigger transformer 8 to excite flash discharge tube 5, and hence flash discharge tube 5 consumes the charging charge of main capacitor 4 to emit light.

When illumination adjustment circuit 12 for flash outputs a light emission stop signal to off-transistor 11 based on the light emission amount of the emitted light reflected from a subject, off-transistor 11 turns on. Then, gate G and emitter E of IGBT 6 are short-circuited. IGBT 6 then turns off to stop the light emission of flash discharge tube 5.

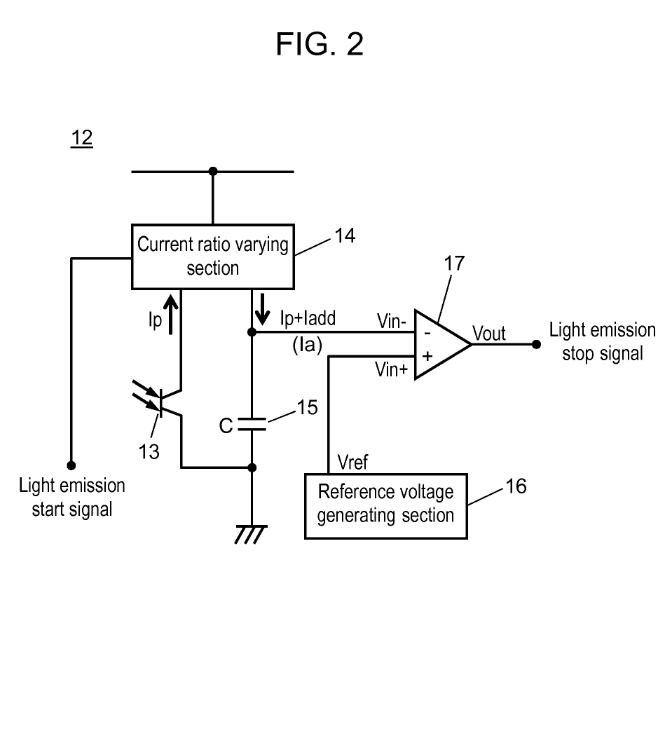

Next, illumination adjustment circuit 12 is described in detail with reference to FIG. 2. FIG. 2 is a circuit diagram of illumination adjustment circuit 12 for flash in accordance with the first exemplary embodiment of the present invention.

Illumination adjustment circuit 12 includes the following elements:
a light receiving element for generating photoelectric current Ip responsive to the intensity of the light reflected from the subject, for example semiconductor light receiving element 13;
current ratio varying section 14;
voltage integrating section 15 (e.g. integrating capacitor);
reference voltage generating section 16; and
voltage comparing section 17.
   Current ratio varying section 14 outputs variable current Ia with the passage of light emission time. Voltage integrating section 15 integrates voltage based on photoelectric current Ip from semiconductor light receiving element 13 and variable current Ia from current ratio varying section 14. Reference voltage generating section 16 outputs reference voltage Vref as a reference of integrated voltage Vint. Voltage comparing section 17 compares integrated voltage Vint with reference voltage Vref.

Semiconductor light receiving element 13 is a light receiving element such as a photodiode or phototransistor for making photoelectric current Ip flow in response to the intensity of the light reflected from the subject. In other words, semiconductor light receiving element 13 is a light receiving element capable of photo-electrically converting the received emitted light into an electric signal of photoelectric current Ip in response to the light intensity.

Current ratio varying section 14 is connected to second terminal 10B of light emission control circuit 10. Current ratio varying section 14 starts the operation in response to the light emission start signal input from light emission control circuit 10. First, current ratio varying section 14 outputs variable current Ia that is obtained by adding a predetermined current (here, additional current Iadd) to photoelectric current Ip input from semiconductor light receiving element 13 in response to the elapsed time from receiving of the light emission start signal.

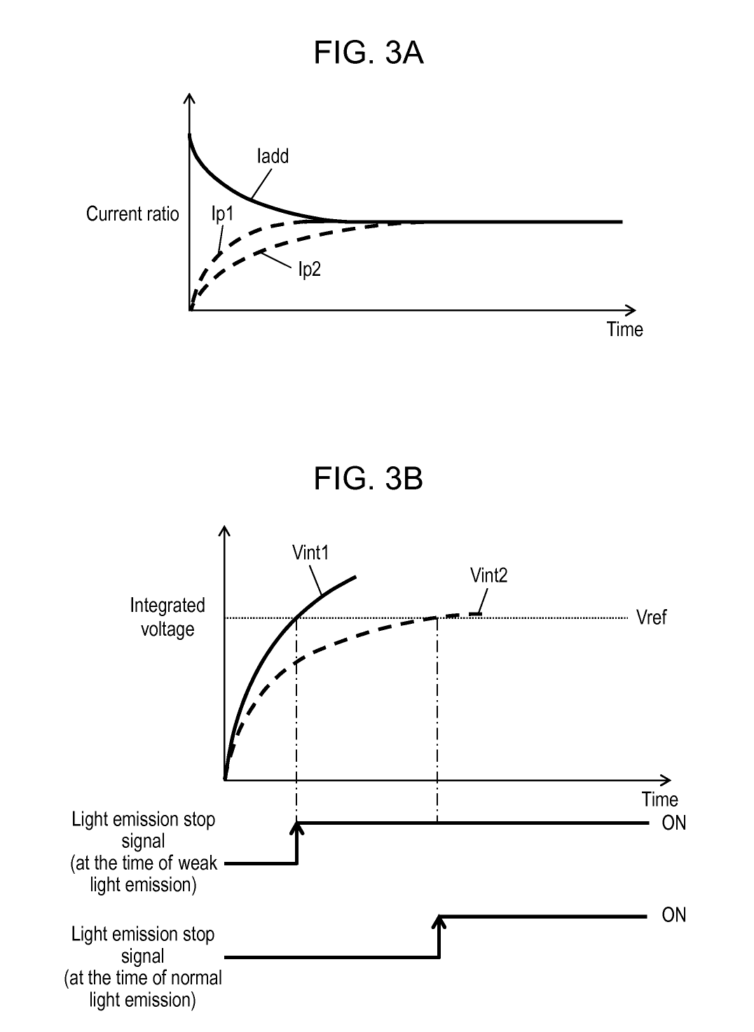

FIG. 3A is a graph showing variation in photoelectric current of a semiconductor light receiving element and variation in additional current of a current ratio varying section in accordance with the first exemplary embodiment of the present invention. FIG. 3B is a graph showing variation in integrated voltage of a voltage integrating section and output timing of a light emission stop signal in accordance with the first exemplary embodiment of the present invention.

Specifically, current ratio varying section 14 starts an operation in response to the light emission start signal as shown in FIG. 3A. The origin of the graph in FIG. 3A is set at the time when current ratio varying section 14 receives the light emission start signal. The broken lines show photoelectric currents Ip1 and Ip2, and the solid line shows additional current Iadd. Photoelectric current Ip1 is obtained when semiconductor light receiving element 13 photo-electrically converts the reflected light received during the short-range photographing. In other words, this value is obtained when the light emission amount is small and appropriate (for example, during weak light emission). Photoelectric current Ip2 is obtained when semiconductor light receiving element 13 photo-electrically converts the reflected light received during the normal photographing. In other words, this value is obtained when the light emission amount is appropriate without correction (for example, during normal light emission).

First, in response to the elapsed time from the receiving of the light emission start signal, current ratio varying section 14 outputs variable current Ia that is obtained by adding a predetermined current (here, additional current Iadd) to photoelectric currents Ip1 and Ip2 generated when semiconductor light receiving element 13 receives the reflected light. Current ratio varying section 14 is connected to second terminal 10B of light emission control circuit 10. Additional current Iadd is supplied from second terminal 10B of light emission control circuit 10.

After the start of the operation, current ratio varying section 14 outputs, to voltage integrating section 15, additional current Iadd that is more than photoelectric current Ip coming from semiconductor light receiving element 13. With the passage of time, additional current Iadd output from current ratio varying section 14 decreases and becomes constant at a predetermined current value.

More preferably, when the distance is short (for example, a distance where the amount of the weak light emission is appropriate), the response delay of semiconductor light receiving element 13 and the time difference until IGBT 6 for controlling the light emission of flash discharge tube 5 turns off are considered. In this case, the output of additional current Iadd from current ratio varying section 14 may be started at the instant when the application of trigger voltage is started in response to the light emission start signal of flash device 30 (simultaneously with pulse transmission from trigger capacitor 7 and trigger transformer 8, which are trigger pulse generating sections of flash device 30).

Voltage integrating section 15 is connected to current ratio varying section 14 as a current source. Voltage integrating section 15 inputs variable current Ia that is obtained by adding predetermined current Iadd to photoelectric current Ip generated in response to the intensity of the reflected light received by semiconductor light receiving element 13.

Voltage integrating section 15 is formed of an integrating capacitor for voltage-integrating variable current Ia coming from current ratio varying section 14. Voltage integrating section 15 charges variable current Ia that is obtained by adding additional current Iadd of current ratio varying section 14 to photoelectric current Ip by semiconductor light receiving element 13, thereby voltage-integrating variable current Ia.

However, the voltage increasing rate of the integrated voltage of voltage integrating section 15 depends on the current amount of input variable current Ia. For example, during the weak light emission, the voltage increasing rate is high like integrated voltage Vint1 of FIG. 3B. During the normal light emission, the voltage increasing rate is lower than that during the weak light emission and is like integrated voltage Vint2 of FIG. 3B.

Reference voltage generating section 16 outputs reference voltage Vref to one input terminal Vin+ of voltage comparing section 17. Reference voltage Vref is set at the same value as integrated voltage Vint obtained when the light emission amount of flash discharge tube 5 is appropriate. Reference voltage Vref output from reference voltage generating section 16 is constant.

Voltage comparing section 17 is a comparator that compares two input signals with each other and inverts the output based on the comparison result. One input terminal (inverting input terminal) Vin+ of voltage comparing section 17 is connected to the output terminal of reference voltage generating section 16, and inputs reference voltage Vref. The other input terminal (non-inverting input terminal) Vin− of voltage comparing section 17 is connected to voltage integrating section 15, and inputs integrated voltage Vint. Specifically, voltage comparing section 17 is connected between voltage integrating section 15 and current ratio varying section 14.

As shown in FIG. 3B, when integrated voltage Vint input from the other input terminal Vin− is less than predetermined reference voltage Vref input from one input terminal Vin+, the potential of output terminal Vout of voltage comparing section 17 is kept at a low level and is not inverted into a high level. When integrated voltage Vint input from the other input terminal Vin− arrives at predetermined reference voltage Vref input from one input terminal Vin+, the potential of output terminal Vout is inverted from the low level into the high level. When the potential of output terminal Vout is inverted into the high level to become a light emission stop signal, off-transistor 11 turns on.

Next, an operation of illumination adjustment circuit 12 having the above-mentioned configuration is described. First, IGBT 6 turns on and flash discharge tube 5 starts light emission. The light emitted from flash discharge tube 5 is reflected from a subject, and enters semiconductor light receiving element 13. Then, photoelectric current Ip is generated in response to the intensity of the reflected light entering semiconductor light receiving element 13.

Generated photoelectric current Ip is input to current ratio varying section 14. Current ratio varying section 14 outputs, to voltage integrating section 15 and voltage comparing section 17, variable current Ia that is obtained by adding predetermined additional current Iadd to photoelectric current Ip in response to the elapsed time from the receiving of the light emission start signal, as shown in FIG. 3A.

Voltage integrating section 15 voltage-integrates variable current Ia input from current ratio varying section 14. Integrated voltage Vint of voltage integrating section 15 is applied to one input terminal Vin− of voltage comparing section 17.

When the light emission start signal is output, due to additional current Iadd added by current ratio varying section 14, variable current Ia more than photoelectric current Ip from semiconductor light receiving element 13 is output to voltage integrating section 15. Thus, at an early time after the start of the light emission, variable current Ia that is obtained by adding additional current Iadd to photoelectric current Ip generated by semiconductor light receiving element 13 is integrated, so that integrated voltage Vint increases steeply. Especially, the light emission amount steeply increases at an early time of the light emission, so that flash discharge tube 5 stops the light emission at a peak time of the light emission when the amount of the weak light emission is appropriate.

At this time, when there is time difference between the receiving of the light emission stop signal and the actual stop of the light emission (namely, the end of the light emission), surplus light amount is generated. In the present invention, however, additional current Iadd is previously added in consideration of the time difference, so that the light emission stop signal can be output immediately before arrival at a desired light emission amount and the time difference can be absorbed.

Variable current Ia where additional current Iadd decreases with the passage of time is set to have a constant current value after the passage of a predetermined time. Therefore, when the light emission amount is normal and appropriate, the increase in additional current Iadd becomes constant after a predetermined elapsed time. Therefore, the light emission stop signal can be output at a desired light emission amount differently from the weak light emission.

Thus, when the amount of the weak light emission is appropriate, the amount of generated photoelectric current Ip1 is large because the light emission amount entering semiconductor light receiving element 13 is large per unit time. The amount of additional current Iadd added by current ratio varying section 14 is also large at an early time of the light emission. The characteristic curve of time and integrated voltage Vint1 steeply increases at an early time of the light emission and arrives at reference voltage Vref in a short time.

When the light emission amount is normal, the amount of generated photoelectric current Ip2 is small because the light emission amount entering semiconductor light receiving element 13 is small per unit time or much time is required until the entering (the distance to the subject is long and time difference until entering of the reflected light occurs). The characteristic curve of time and integrated voltage Vint2 steeply increases at an early time of the light emission, but increases gradually gently because additional current Iadd decreases with the passage of time.

Thus, when integrated voltage Vint exceeds reference voltage Vref, the potential of output terminal Vout of voltage comparing section 17 is inverted into the high level. Off-transistor 11 then turns off, so that flash discharge tube 5 stops the light emission.

In illumination adjustment circuit 12 for flash of the first exemplary embodiment, by outputting variable Ia from current ratio varying section 14 to voltage integrating section 15, integrated voltage Vint of voltage integrating section 15 is varied in response to the following light emission/photographing condition: the photographing distance is short, the photographing sensitivity is high, or the stationary light is relatively strong. Thus, the time until integrated voltage Vint arrives at reference voltage Vref can be varied. Therefore, illumination adjustment circuit 12 for flash can perform stable illumination adjustment control even when the switching of the characteristic curve of time and integrated voltage Vint or the time loss during the switching are not considered.

In other words, the illumination adjustment circuit for flash of the present invention includes the following elements:
a light receiving element for generating photoelectric current responsive to the intensity of the light reflected from a subject;
a voltage integrating section for voltage-integrating the photoelectric current from the light receiving element; and
a voltage comparing section for comparing the voltage of the voltage integrating section with a reference voltage.
   The illumination adjustment circuit for flash further includes a current ratio varying section for outputting variable current to the voltage integrating section with the passage of light emission time.

In this configuration, by outputting variable current from the current ratio varying section to the voltage integrating section, the time until the integrated voltage arrives at the reference voltage can be varied. In other words, in the light emission/photographing condition requiring feeble light emission, for example when the photographing distance is short, the photographing sensitivity is high, or the stationary light is relatively strong, the current ratio varying section increases the variable current in order to shorten the time until the integrated voltage arrives at the reference voltage. Thus, the integrated voltage can increase the voltage increasing rate. In the light emission/photographing condition requiring a normal light emission amount, the current ratio varying section decreases the variable current. Thus, the integrated voltage allows that the time until the integrated voltage arrives at the reference voltage is matched with the time capable of securing the light emission amount of the emitted light and the illumination adjustment accuracy for each light emission/photographing condition can be improved.

The current ratio varying section adjusts the variable current in response to the photoelectric current generated by the light receiving element.

In this configuration, the current ratio varying section varies the variable current amount based on the increasing rate of the photoelectric current generated by the light receiving element. Thus, the time until the integrated voltage arrives at the reference voltage value can be adjusted, and the light emission amount of the emitted light can be further accurately adjusted.

### Second Exemplary Embodiment

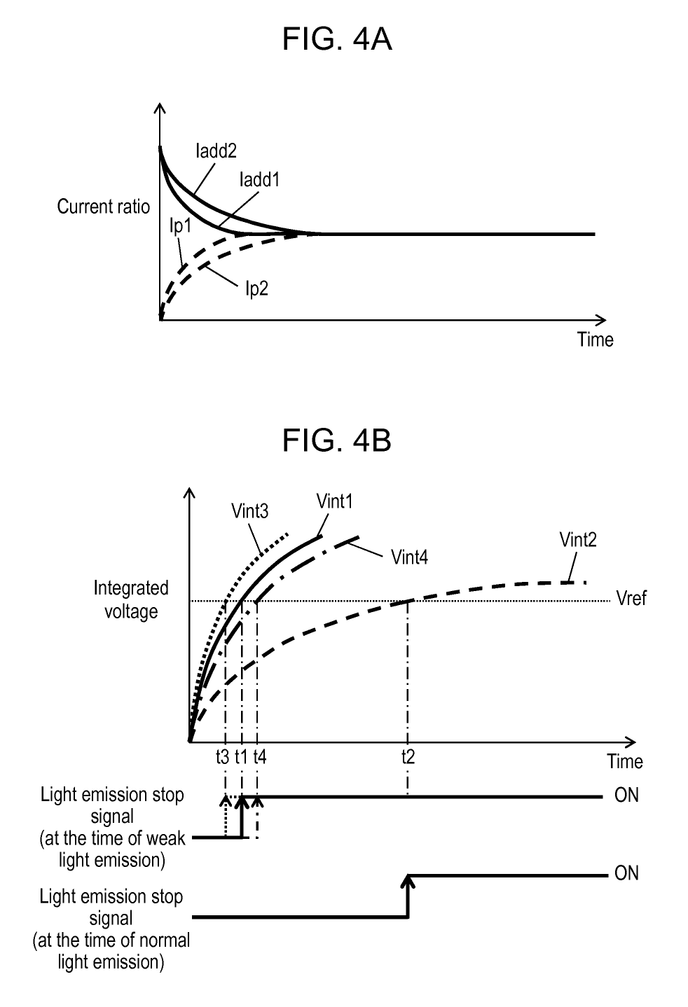

A flash device of a second exemplary embodiment of the present invention is described with reference to FIG. 4A and FIG. 4B. FIG. 4A is a graph showing variation in photoelectric current of a semiconductor light receiving element and variation in additional current of a current ratio varying section in accordance with a second exemplary embodiment of the present invention. FIG. 4B is a graph showing variation in integrated voltage of a voltage integrating section and output timing of a light emission stop signal in accordance with the second exemplary embodiment of the present invention. The flash device of the second exemplary embodiment has a configuration similar to that of the first exemplary embodiment except for current ratio varying section 14 of illumination adjustment circuit 12 for flash. The other elements of the second exemplary embodiment are similar to those of FIG. 1 and FIG. 2. The elements similar to those in the first exemplary embodiment except current ratio varying section 14 are denoted with the same reference marks, and the descriptions of those elements are omitted.

In current ratio varying section 14 of the second exemplary embodiment, when the incident amount of the reflected light to semiconductor light receiving element 13 is large, namely when the light emission amount is small and appropriate (weak light emission), photoelectric current Ip1 steeply increases after the start of the light emission. Thus, additional current Iadd1 is output in response to photoelectric current Ip1. The current decreasing rate of additional current Iadd1 is reduced in contract to the current increasing rate of photoelectric current Ip1.

In current ratio varying section 14, when the incident amount of the reflected light to semiconductor light receiving element 13 is appropriate, namely when the light emission amount is appropriate without correction (normal light emission), photoelectric current Ip2 increases at a normal current increasing rate after the start of the light emission. Then, current ratio varying section 14 outputs additional current Iadd1 in response to photoelectric current Ip2 similarly to the time of weak light emission. The current decreasing rate of additional current Iadd2 is reduced in contract to the current increasing rate of photoelectric current Ip2. The decreasing rates of additional currents Iadd1 and Iadd2 may be varied in response to the increasing rate of the photoelectric current amount based on a reference table previously stored in a memory or the like.

Therefore, the decreasing rates of additional currents Iadd1 and Iadd2 are varied in response to different photoelectric currents Ip1 and Ip2 generated by semiconductor light receiving element 13. Thus, times t1 and t2 taken until integrated voltages Vint1 and Vint2 arrive at reference voltage Vref can be adjusted in response to the light receiving amount of the reflected light.

Furthermore, the decreasing rate of additional current Iadd is varied in response to photoelectric current Ip1 generated by semiconductor light receiving element 13. Thus, times t3 and t4 taken until integrated voltages Vint3 and Vint4 arrive at reference voltage Vref can be finely adjusted in response to the light receiving amount, and more accurate illumination adjustment control can be performed.

Next, a flash device of another exemplary embodiment of the present invention is described with reference to FIG. 2. The flash device of the second exemplary embodiment has a configuration similar to that of the first exemplary embodiment except for current ratio varying section 14 of illumination adjustment circuit 12 for flash. The elements similar to those in the first exemplary embodiment except current ratio varying section 14 are denoted with the same reference marks, and the descriptions of those elements are omitted.

In the configuration of current ratio varying section 14 of the second exemplary embodiment, the current flow direction (arrow Ip) of photoelectric current Ip of FIG. 2 is reversed.

In the operation of illumination adjustment circuit 12 of the second exemplary embodiment, IGBT 6 turns on and flash discharge tube 5 starts the light emission. The light emitted from flash discharge tube 5 is reflected from a subject and enters semiconductor light receiving element 13, and semiconductor light receiving element 13 generates photoelectric current Ip responsive to the intensity of the entering reflected light.

Current ratio varying section 14 measures photoelectric current Ip generated by semiconductor light receiving element 13, adds predetermined additional current Iadd responsive to the elapsed time from receiving of a light emission start signal to the current amount of photoelectric current Ip in response to photoelectric current Ip, and outputs the addition result as variable current Ia to voltage integrating section 15 and voltage comparing section 17.

Variable current Ia output from current ratio varying section 14, which is larger than the output of photoelectric current Ip from semiconductor light receiving element 13 when the light emission start signal is output, is output to voltage integrating section 15.

Thus, at an early time after the start of the light emission, variable current Ia obtained by adding additional current Iadd to photoelectric current Ip generated by semiconductor light receiving element 13, so that integrated voltage Vint increases steeply. Especially, the light emission amount increases steeply at an early time of the light emission, so that the light emission is stopped at a peak time of the light emission when the amount of the weak light emission is appropriate.

The illumination adjustment circuit for flash of the present invention and a flash device using it are not limited to the above-mentioned embodiments, but can be changed as long as they do not go out of the scope of the present invention.

For example, as current ratio varying section 14 of the present invention, an example where additional current Iadd decreases to a predetermined current amount with respect to the increase of photoelectric current Ip has been described. However, the present invention is not limited to this. In other words, additional current Iadd may decrease to 0 A.

### Third Exemplary Embodiment

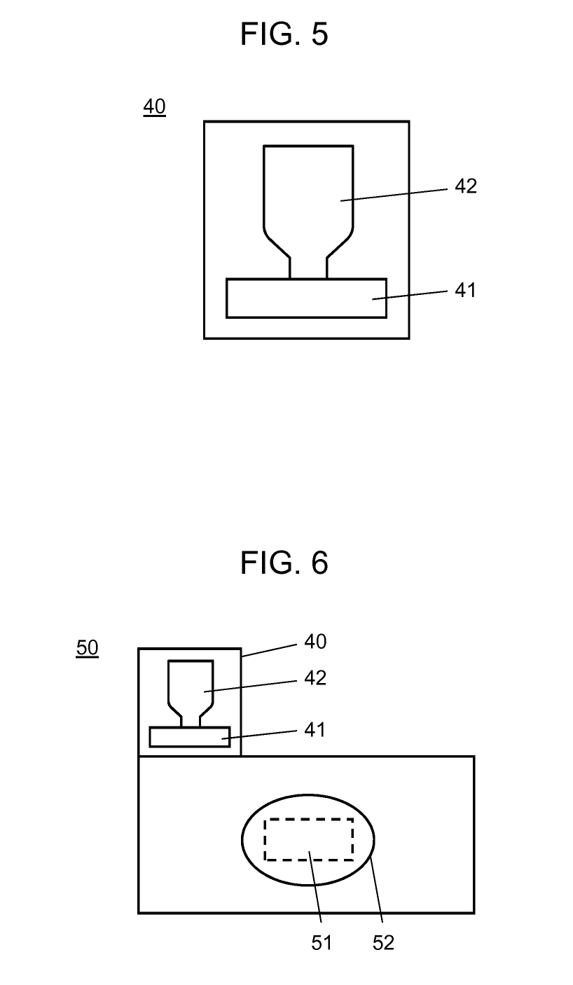

FIG. 5 is a schematic front view of a flash device in accordance with a third exemplary embodiment of the present invention. As shown in FIG. 5, flash device 40 of the third exemplary embodiment includes illumination adjustment circuit 41 for flash and light emitting element 42 for emitting light of the first or second exemplary embodiment.

In the configuration, a flash device can be achieved which can match the time until arrival at the reference voltage with the time capable of securing the light emission amount of the emitted light and can improve the illumination adjustment accuracy for each light emission/photographing condition.

### Fourth Exemplary Embodiment

FIG. 6 is a schematic front view of an image capture device in accordance with a fourth exemplary embodiment of the present invention. In FIG. 6, image capture device 50 of the fourth exemplary embodiment includes flash device 40, image capture element 51, and optical system 52 for image capture.

In the configuration, an image capture device can be achieved which can match the time until arrival at the reference voltage with the time capable of securing the light emission amount of the emitted light and can improve the illumination adjustment accuracy for each light emission/photographing condition.

### INDUSTRIAL APPLICABILITY

The illumination adjustment circuit for flash of the present invention and the flash device using it are useful as an illumination adjustment circuit for flash that improves the illumination adjustment accuracy for each light emission/photographing condition and improves the light emission amount of the light emitted from a flash discharge tube and as a flash device using the illumination adjustment circuit.

### REFERENCE MARKS IN THE DRAWINGS

1 power supply battery
2 power supply switch
3 voltage boost circuit
4 main capacitor
5 flash discharge tube (light emitting element)
6 IGBT
7 trigger capacitor
8 trigger transformer
9 light emission stop circuit
10 light emission control circuit
10A first terminal
10B second terminal
10C input terminal
11 off-transistor
12, 41 illumination adjustment circuit
13 semiconductor light receiving element
14 current ratio varying section
15 voltage integrating section
17 voltage comparing section
30, 40 flash device
42 light emitting element
50 image capture device
51 image capture element
52 optical system

1. An illumination adjustment circuit for flash comprising:
a light receiving element for generating a photoelectric current responsive to intensity of light reflected from a subject;
a voltage integrating section for voltage-integrating the photoelectric current from the light receiving element; and
a voltage comparing section for comparing a voltage of the voltage integrating section with a reference voltage,
wherein the illumination adjustment circuit for flash further comprises a current ratio varying section for outputting a variable current to the voltage integrating section with the passage of light emission time.

2. The illumination adjustment circuit for flash of claim 1, wherein the current ratio varying section adjusts the variable current in response to the photoelectric current generated by the light receiving element.

3. A flash device comprising:
the illumination adjustment circuit for flash of one of claim 1 and claim 2; and
a light emitting element for emitting light.

4. An image capture device comprising:
the flash device of claim 3;
an image capture element; and
an optical system for image capture.
